(19) United States
(12) Patent Application Publication
(10) Pub. No.: US 2005/0253123 A1
(43) Pub. Date: Nov. 17, 2005

(54) Apparatus for moving shelving

(76) Inventor: Dan Sonnenberg, Vergas, MN (US)

Correspondence Address: Richard C. Litman;LITMAN LAW OFFICES, LTD., P.O. Box 15035, Arlington, VA, 22215, US

(21) Appl. No.: 10/844,433

(22) Filed: May 13, 2004

(51) Int. Cl. B66F 3/36

(52) U.S. Cl. 254/100

(57) ABSTRACT

An apparatus for moving shelving, comprising an elongated housing, a locking pin, a first hollow shaft, a second hollow shaft, an elongated push member, a nut member, an elongated threaded rod, a drive shaft, and a base plate. The drive shaft is adapted to be rotated by a drive mechanism such as a power drill, wherein rotation in the drive shaft causes rotation in the threaded rod to push the push member away from the housing to move shelving.

### BACKGROUND OF THE INVENTION

1. Field of the Invention

The present invention relates to moving devices. Specifically, the invention is a moving device adapted to move aisle shelving.

2. Description of the Related Art

Retail outlets such as discount stores and supermarkets make use of shelving to hold merchandise intended for sale to the public. Shelving is often installed in rows or “runs” and is sometimes referred to as “gondolas”. The rows or runs create aisles or passages. Specifically, each aisle is defined by opposite rows of shelving. A shopper typically walks along an aisle with a shopping trolley and scans both sides of the aisle, stopping intermittently to select and remove merchandise off one of the opposite rows of shelving. The shopper moves the selected merchandise to a checkout station where the shopper purchases the merchandise.

Rows of shelving are found in other types of buildings such as public libraries where books are stored on rows of shelves. A library member typically walks along a row of books, stopping to select a book. Once the library member has selected one or more books the member typically heads for a library check out desk.

Sometimes it is necessary to move shelving. For example, a remodeling design for a retail store that calls for rearranging the shopping aisles. Significant labor is involved in moving shelves, particularly shelves full of items such as merchandise or books. Typically the shelves are emptied of their contents, dismantled, and reassembled at a new position and the contents returned to the shelves. Some shelving is adapted to be lifted and moved using mechanical lifting apparatus.

Sometimes it is only necessary to move shelving a few inches or by a foot or so. However, moving shelving just a short distance still entails emptying or using lifting apparatus to move the shelving over a short distance. Thus, there has been a long felt and unmet need for an apparatus that can move shelving over a relatively short distance without requiring awkward and expensive lifting apparatus or the emptying and reloading of shelves.

A review of the prior art follows.

U.S. Pat. No. 3,879,053, issued Apr. 22, 1975 to W. J. Chvala, describes a mobile display cart with a kick plate mounted to the bottom of the cart for anchoring the cart. The '053 patent does not teach or suggest an apparatus as claimed in the present invention to move otherwise non-mobile shelving or gondolas.

U.S. Pat. No. 5,012,879 issued May 7, 1991 to Bienek et al., describes a self propelled jacking apparatus for transporting loads and adjusting the height of the load. The '879 patent does not teach or suggest an apparatus for horizontally pushing or nudging a permanent or otherwise non-mobile shelving or gondolas.

U.S. Pat. No. 6,238,159 B1 issued May 29, 2001 to S. Pappas, describes an installation device that provides controlled vertical movement of materials with a hydraulic jack modified to accept the chuck of a power drill. The '159 patent does not teach or suggest an apparatus for horizontally pushing or nudging a permanent or otherwise non-mobile shelving or gondolas.

U.S. Pat. No. 6,460,827 issued Oct. 8, 2002 to D. A. Baucom describes a lifting and movement system for lifting a complete run of shelving having a plurality of shelf units and for moving the shelving along a floor surface to a desired location. First and second frame structures are defined by interconnected modular frame assemblies so as to have sufficient length to extend along the entire length of a run of shelving. Wheels such as casters are mounted to the first frame to provide for movement of the lifting system and the run of shelving along the floor surface to a desired location. A second, movable frame is in vertically movable assembly with the first frame and has shelving engaging components for lifting engagement with the run of shelving. A plurality of lift elements is supported by the first frame and provides support for the second frame and the shelving engaged thereby. A power system, which is preferably a pneumatic pressure supply, is in controllable relation with each of the lift elements and is selectively operable for simultaneously activating each of the lift elements for simultaneous lifting or lowering of all of the modular sections of the second frame relative to the first frame to thereby provide for selective lifting or lowering of the shelving. The '827 patent expressly teaches away from the present invention. Specifically, the '827 patent does not teach or suggest an apparatus for horizontally pushing or nudging a permanent or otherwise non-mobile shelving or gondolas.

None of the above inventions and patents, taken either singly or in combination, is seen to describe the instant invention as claimed. Thus an apparatus for moving shelving solving the aforementioned problems is desired.

### SUMMARY OF THE INVENTION

An apparatus for moving shelving, comprising an elongated housing, a locking pin, a first hollow shaft, a second hollow shaft, an elongated push member, a nut member, an elongated threaded rod, a drive shaft, and a base plate. The drive shaft is adapted to be rotated by a drive mechanism such as a power drill, wherein rotation in the drive shaft causes rotation in the threaded rod to push the push member away from the housing to move shelving.

Accordingly, it is a principal object of the invention to provide an apparatus for moving shelving.

It is another object of the invention to provide an apparatus adapted to move retail shelving without lifting the shelving.

It is a further object of the invention to provide an apparatus adapted to move retail shelving without having to first remove merchandise from the shelves thereby reducing the amount of human labor and reducing the risk of damage to the merchandise.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a moving device for moving shelving according to the present invention.

FIG. 2 is another environmental, perspective view of a moving device for moving shelving according to the present invention.

FIG. 3 is a top view of the moving device of FIG. 2.

FIG. 4 is a section view drawn along lines 4a′-4a″ of the moving device in FIG. 3.

FIG. 5 is a partly exploded view of the moving device of FIG. 2.

FIG. 5a is a perspective view of an extension that can be used with the moving device for moving shelving.

FIG. 6 is an environmental, perspective view of a prior art moving device for moving shelving.

Similar reference characters denote corresponding features consistently throughout the attached drawings.

### DETAILED DESCRIPTION OF THE PREFERRED EMBODIMENTS

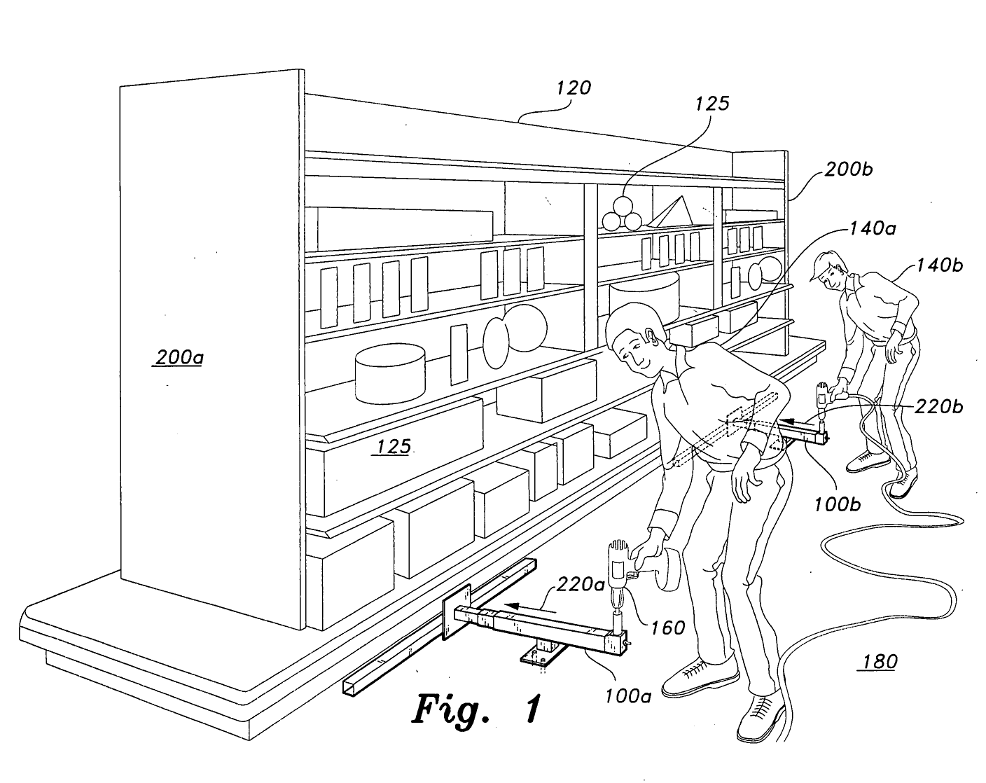

The present invention is directed to a moving device adapted to move shelving. The moving device according to the invention is referred to generally using the reference numeral 100 or numerical derivatives thereof such as 100a and 100b as used in FIG. 1.

FIG. 1 is an environmental, perspective view of a moving device for moving shelving 120 according to the present invention. A plurality of merchandise 125 is located on the shelving 120. An operator 140a is shown operating a drive mechanism (shown as a drill 160) attached to a first moving device 100a according to the present invention. The moving device 100a is positioned and attached to a floor 180 so as to abut against the shelving 120. The operator 140a is using the moving device 100a to push the shelving 120 away from the moving device 100a.

The shelving 120 has two opposite ends 200a and 200b. The operators 140a and 140b are using the moving devices 100a and 100b to respectively push opposite ends 200a and 200b in the direction of arrows 220a and 220b as shown in FIG. 1. While shelving can resist significant downward loads, lateral loads (i.e., sideways forces) can distort shelving. Thus, more than one moving device 100 might be used as required to move a long merchandize shelf 120.

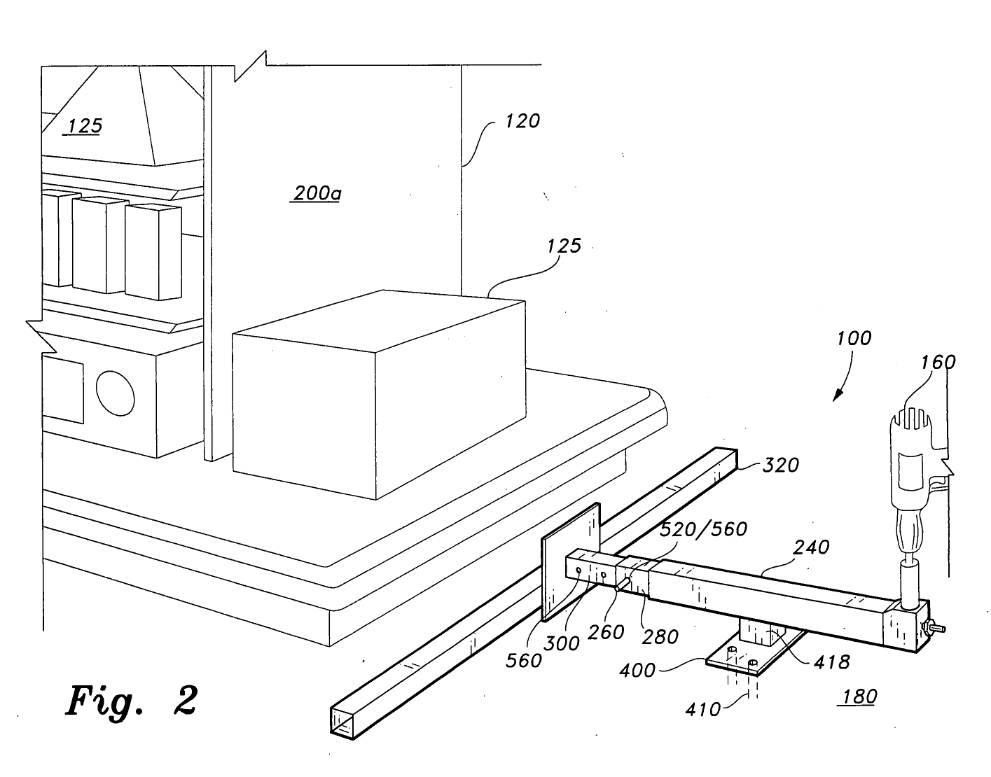

FIG. 2 shows how the moving device 100 might be used to move a shelf 120 lengthwise. The elongated push member 320 is positioned to abut against a shelf end 200a to push the shelving lengthwise. Thus, the moving device 100 can be used to move a shelf 120 either lengthwise or sideways (as depicted in FIG. 1).

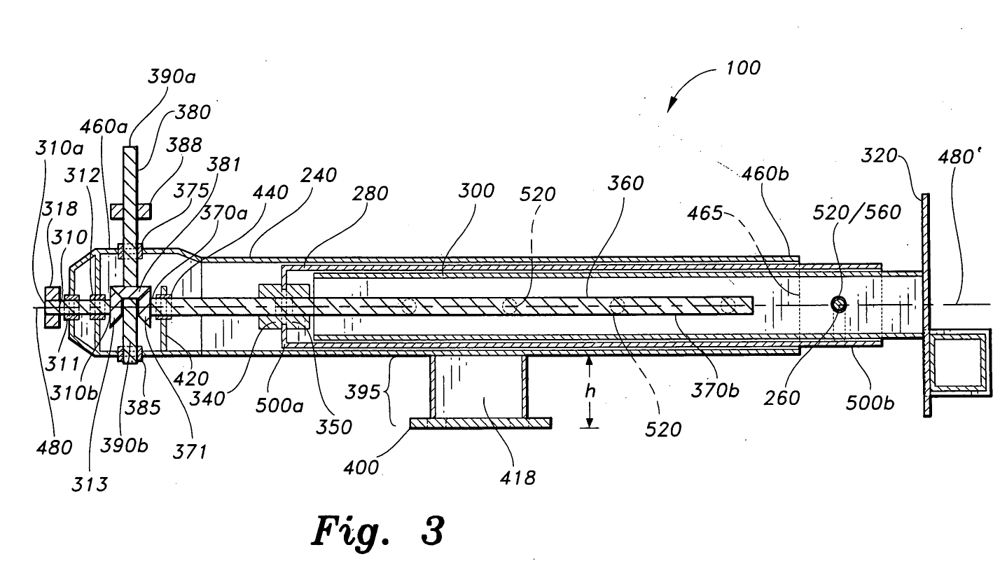

FIG. 3 shows a section view of the moving device 100. The moving device 100 comprises an elongated housing 240, a locking pin 260, a first hollow shaft 280, a second hollow shaft 300, an elongated push member 320, a nut member 340, an elongated threaded rod 360, a drive shaft 380, and a base 395. The moving device 100 further comprises a rod support pillar 420 and an optional rod mounting bearing member 440.

With respect to FIGS. 3, 4 and 5, the elongated housing 240 has a first 460a and second 460b opposite ends and a longitudinal axis 480-480′; the second end 460b defines an opening 465 to allow the outward extension of the hollow shafts 280 and 300. The housing 240 is shown with a generally elongated rectangular shape; however it should be understood that the overall shape and configuration of the housing 240 might vary without detracting from the scope of the invention.

The first hollow shaft 280 has a generally elongated shape with first 500a and second 500b opposite ends, and is configured to reversible extend from the housing 240. In normal use of the moving device 100, the first end 500a never quite leaves the housing 240. The first hollow shaft 280 has a pair of opposite sides that define a pair of opposite facing perforations 520 proximate to the second end 500b that can be aligned with any one of the plurality of pairs of perforations 560 defined in the second hollow shaft 300.

The second hollow shaft 300 has a generally elongated shape with first 540a and second 540b opposite ends, wherein the second hollow shaft 300 is configured to reversibly extend from the first hollow shaft 280. The second hollow shaft 300 has a pair of opposite sides that collectively define a plurality of opposite facing perforations 560 that can be selectively aligned with the single pair of perforations 520 in the first hollow shaft 280.

Each of the plurality of opposite facing perforations 560 are adapted to accommodate the locking pin 260 such that the second shaft 300 can be firmly attached to the first shaft 280 by an operator 140 aligning a suitable pair of perforations 560 with the pair of perforations 520 in the first shaft 280, and placing the locking pin 260 through the aligned perforations 520 and 560. Rotating the elongated threaded rod 360 (discussed in more detail below) acts on the nut member 340, which has an internal threaded bore 350, to extend the first shaft 280 (and the attached second shaft 300) away from the housing 240, and more particularly from the housing end 460b. Upon extension of the shafts 280 and 300, the operator 140 removes the pin 260 and counter rotates the shaft 360 to drive the first shaft 280 back into the housing 240 independently from the de-attached or decouple second shaft 300; the operator 140 should take care to align the apertures 520 with a fresh pair of apertures 560. Then the operator 240 reattaches the second shaft to the first shaft using the locking pin 260. Once the second shaft 300 is firmly reattached to the first shaft 280 both shafts 280 and 300 once again move in unison to allow the shaft combination 280 and 300 to progressively extend out of the second end 460b of the housing 240.

For example, when the first hollow shaft 280 is extended to its maximum extent, the operator 140 decouples the first shaft 280 from the second shaft 300 by removing the locking pin 260 holding the two shafts 280 and 300 together. After decoupling the first shaft 280 is independently driven back into the housing 240 while keeping the second shaft 300 stationary. The second shaft 300 is then reconnected to the first shaft 280 by aligning the pair of perforations 520 with a suitable pair of apertures selected from the plurality of apertures 560 defined in the second shaft 300.

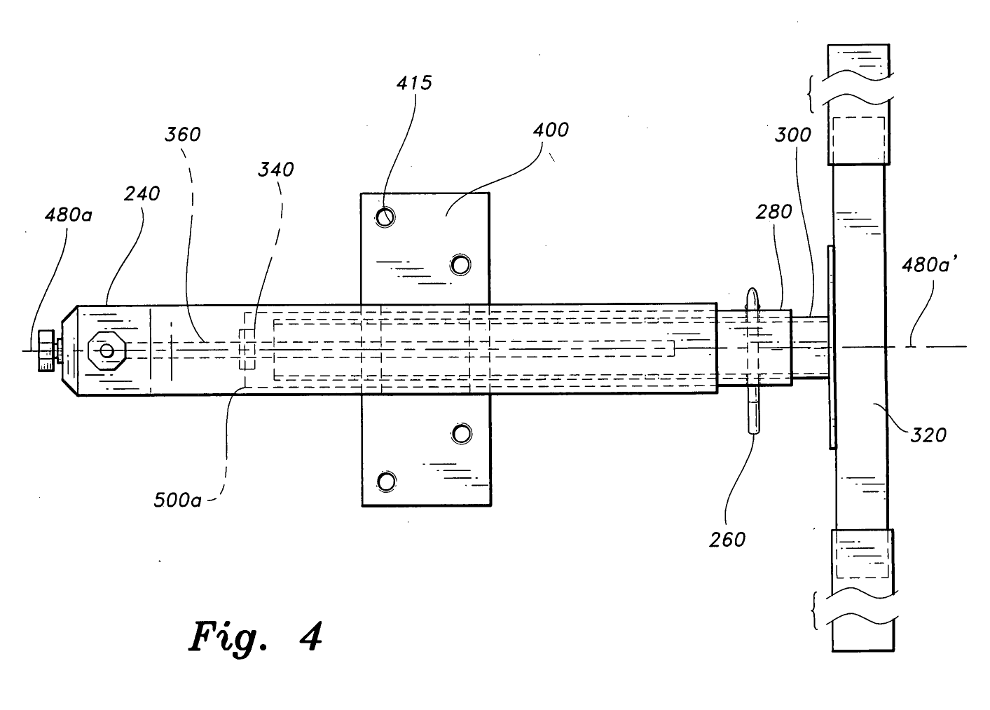

The elongated push member 320 is attached to the second end 540b of the second hollow shaft 300, wherein the push member 320 is substantially perpendicular to the second hollow shaft 300 and elongated axis 480-480′. In normal use the push member 320 is positioned along a shelf 120 at floor level 180. The first end 500a of the first hollow shaft 280 is adapted to firmly hold the nut member 340 as shown in FIG. 4. As mentioned previously, the nut member 340 comprises the internal threaded bore 350.

The elongated threaded rod 360 has a first 370a and second 370b opposite ends. The rod 360 is threaded through the internal threaded bore 350 in the nut member 340. The first end 370a of the rod 360 is adapted to mechanically communicate with a drive shaft 380. The rod 360 can be rotated in a clockwise or anti-clockwise direction in response to rotation induced in the drive shaft 380 by a drive mechanism such as a drill 160 to rotate the drive shaft 380.

The drive shaft 380 is housed in the first end 460a of the housing 240 and passes through bearing 375 and bearing 385, wherein the drive shaft 380 defines a first 390a and second 390b opposite ends, wherein the second end 390b is adapted to mechanically communicate with the first end 370a of the rod 360. In the preferred embodiment the means of mechanical communication are a forward drive gear 381 and a main drive gear 371. The first end 390a is adapted to connect to a drive mechanism such as a drill 160. 390a can be either have a smooth shank or have a nut 388 attached for use with a socket. The preferred embodiment also has a second drive shaft 310 that passes through the end of housing 240 and is supported by bearing 311 and bearing 312. The first end 310a of the second drive shaft 310 is adapted to connect to a drive mechanism such as a drill 160 and can have either a smooth shank or a nut 318 attached for use with a socket. The second end 310b of the second drive shaft 310 is connected to an optional high speed reverse drive gear 313.

The base 395 is connected to the bottom of the housing 240, wherein the base 395 comprises a base plate 400 and pillar 418; the base pillar 418 separates the base plate 400 from the housing 240 (represented by alpha symbol “h” in FIG. 3) in order to provide clearance for the push-member 320. Floor attachment members such as bolts 410 are used to attach the base plate to the floor 180 such as one or more bolts 410 via bolt holes 415 defined in the base plate 400. It will be understood that any suitable method of attachment can be used to attach the base plate 400 to the floor 180. It will also be understood that the base 395 might be configured in a variety of ways without detracting from the scope and spirit of present invention; e.g., the base pillar 418 might be omitted and the base plate 400 directly connected to the housing 240 if the push-member 320 is configured to be flush with the housing 240 and thereby not require ground clearance.

An operator 140 uses a drive mechanism such as a drill 160 to rotate the drive shaft 380 or the second drive shaft 310 and thence rod 360. The rod support pillar 420 and optional rod mounting bearing member 440 provide support for the rod 360. Rotating the rod 360 extends the first 280 and second 300 shafts from the housing 240. More specifically, movement in the first shaft 280 is simultaneously transferred to the second shaft 300, which is connected to the first shaft using the locking pin 260 as previously described, and to the elongated push member 320 that moves the shelving 120 as shown in FIG. 1.

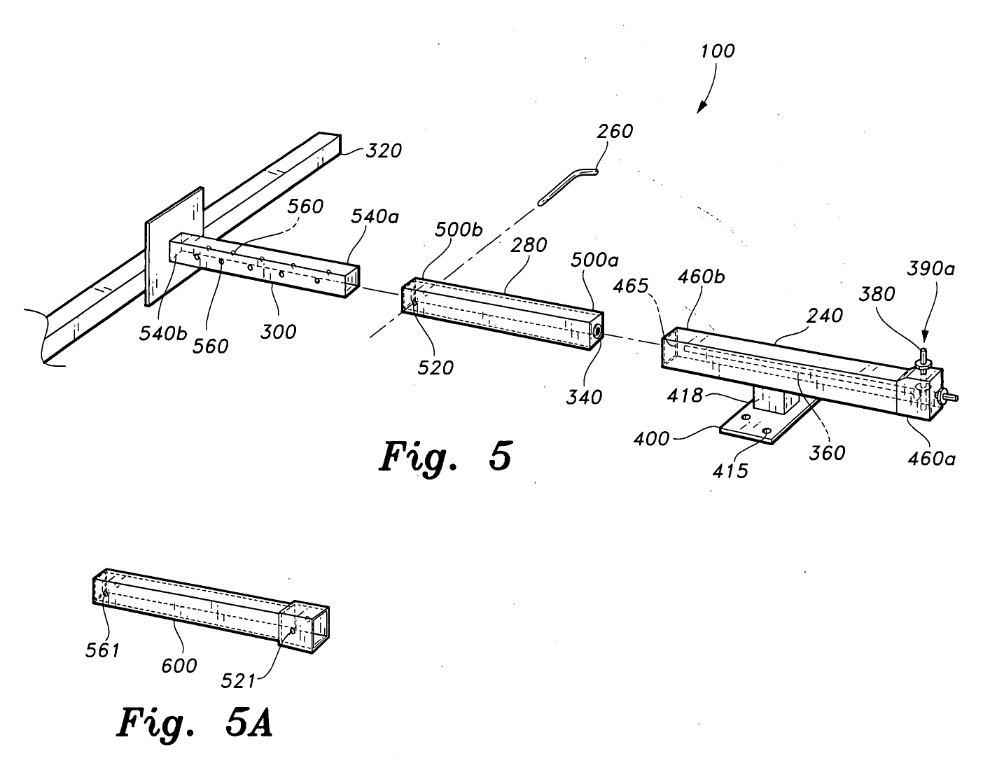

FIG. 5a shows an extension 600 that can be used with the moving device for moving shelving 100. When the first hollow shaft 280 is extended to its maximum extent, the operator 140 decouples the first shaft 280 from the second shaft 300 by removing the locking pin 260 holding the two shafts 280 and 300 together. After decoupling the first shaft 280 is independently driven back into the housing 240 while keeping the second shaft 300 stationary. At this point extension 600 can be connected to first shaft 300 by means of locking pin 260 that goes through aperture 520 and extension front aperture 521. The second shaft 300 is then connected to the extension 600 by aligning the pair of extension back perforations 561 with a suitable pair of apertures selected from the plurality of apertures 560 defined in the second shaft 300. It is contemplated that more than one extension could be used with the present invention.

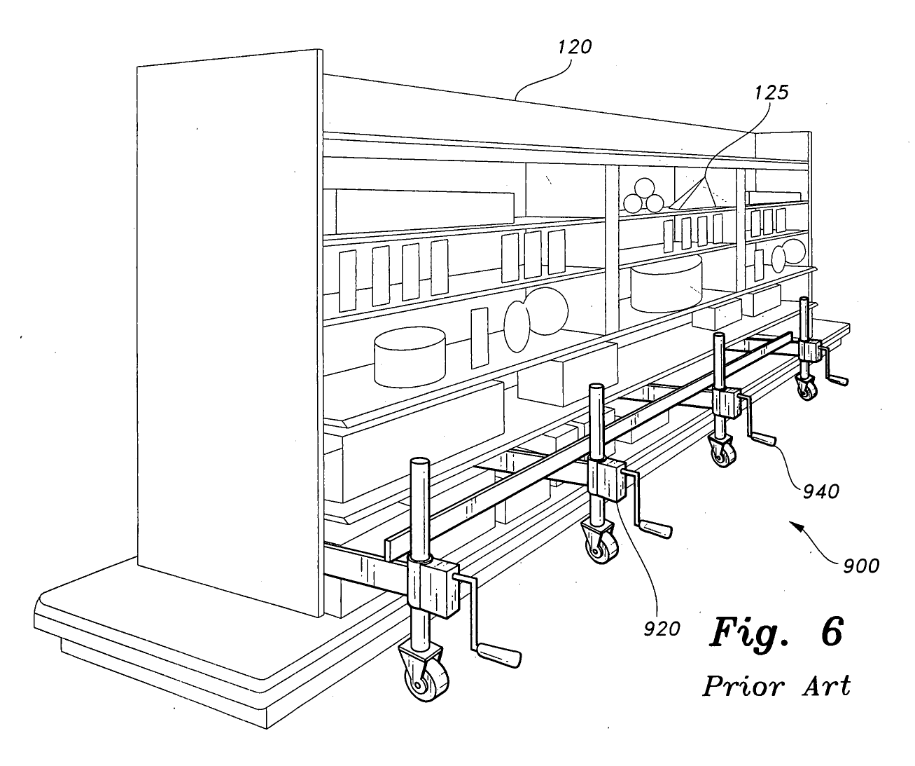

FIG. 6 shows mechanical lifting apparatus 900 of the prior art. The lifting apparatus 900 uses a plurality of lifting stations 920 fitted with hand cranks 940 to lift the shelving 120. Each of the stations 920 must be manned to ensure an equal rate in turning the hand cranks 940 to avoid inducing high load stresses on the shelving 120 that can otherwise cause the shelving 120 to distort. Using the mechanical lifting apparatus 900 to move shelving 120 a short distance require more labor and effort than using the moving device 100 of the present invention.

It is to be understood that the present invention is not limited to the embodiments described above, but encompasses any and all embodiments within the scope of the following claims.

1. An apparatus for moving shelving, comprising:
an elongated housing having a first and second opposite ends and a longitudinal axis, wherein the housing defines a generally elongated shape, wherein the second opposite end of the housing defines an opening;
a first and a second hollow shaft adapted to extend away from the opening in the second end of the housing, wherein each hollow shaft has a first and second opposite ends;
a means to reversibly attach the second hollow shaft to the first hollow shaft;
a means to extend the first and second hollow shafts out of the second end of the housing;
an elongated push member attached to the second end of the second hollow shaft;
a means to attach the housing to a floor;
whereby an operator can use a drive mechanism to extend the first and second hollow shafts out of the second end of the housing to enable the push member to move shelving.

2. An apparatus for moving shelving, comprising:
an elongated housing having a first and second opposite ends and a longitudinal axis, wherein the housing defines a generally elongated shape, wherein the second opposite end of the housing defines an opening;
a first hollow shaft having a first and second opposite ends, wherein the first hollow shaft is located inside the housing, wherein the first end of the first hollow shaft faces the first end of the housing;
a second hollow shaft having a first and second opposite ends, wherein the second hollow shaft is located inside the first hollow shaft with the first end of the second hollow shaft facing the first end of the first hollow shaft;
an elongated push member attached to the second end of the second hollow shaft;
a nut member, wherein the first end of the first hollow shaft is adapted to firmly hold the nut member in a perpendicular orientation relative to the longitudinal axis of the housing, wherein the nut member comprises an internal threaded bore;
an elongated threaded rod having a first and second opposite ends, wherein the rod is threaded through the internal threaded bore;
a drive shaft housed in the first end of the housing, wherein the drive shaft defines a first and second opposite ends, wherein the first end of the drive shaft is adapted to mechanically communicate with the first end of the rod, and the second end of the drive shaft is adapted to connect to a drive mechanism, wherein the rod can be rotated in a clockwise or anti-clockwise direction in response to rotation induced in the drive shaft;
a base plate connected to the bottom of the housing, wherein the base plate is adapted to firmly attach to a floor; and
a locking pin, wherein the first and second shafts are adapted to be temporarily locked together by the locking pin;
whereby an operator can use a drive mechanism to rotate the drive shaft and thence rotate the rod to cause the first end of the first shaft to extend away from the first end of the housing thereby simultaneously extending the first and second hollow shafts from the open second end of the housing and thence moving the elongated push member away from the housing to push shelving, whereby upon removing the locking pin joining the first and second hollow shafts and rotating the rod in the opposite direction allows the first shaft to be driven back into the housing independently of the second shaft whereupon an operator can rejoin the second shaft to the inner shaft by placing the locking pin through a pair of aligned apertures in the first and second shafts.

3. An apparatus for moving shelving, comprising:
an elongated housing having a first and second opposite ends and a longitudinal axis, wherein the housing defines a generally elongated shape;
a locking pin;
a first hollow shaft having a first and second opposite ends, wherein the first hollow shaft is located inside the housing, wherein the first end of the first hollow shaft faces the first end of the housing, wherein the second end of the first hollow shaft can be extended from the second end of the housing, wherein the first hollow shaft has a generally elongated shape adapted to fit inside the housing, wherein the first hollow shaft has a pair of opposite sides that define a pair of opposite facing perforations proximate to the second opposite end of the first hollow shaft, wherein the opposite facing perforations are adapted to accommodate the locking pin;
a second hollow shaft having a first and second opposite ends, wherein the second hollow shaft is located inside the first hollow shaft with the first end of the second hollow shaft facing the first end of the first hollow shaft, wherein the second end of the second hollow shaft can be extended out of the second end of the first hollow shaft, wherein the second hollow shaft defines a generally elongated rectangular shape with two pairs of opposite sides, wherein one pair of opposite sides define at least one pair of second complementary apertures positioned to selectively align with the at least one pair of first complementary apertures, and wherein the at least one pair of second complementary apertures are adapted to accommodate the locking pin such that movement of the first hollow shaft is causes simultaneous movement in the second hollow shaft;
an elongated push member attached to the second opposite end of the second hollow shaft, wherein the push member is substantially perpendicular to the second hollow shaft;
a nut member, wherein the first end of the first hollow shaft is adapted to firmly hold the nut member in a perpendicular orientation relative to the longitudinal axis of the housing, wherein the nut member comprises an internal threaded bore;
an elongated threaded rod having a first and second opposite ends, wherein the rod is threaded through the internal threaded bore;
a drive shaft housed in the first end of the housing, wherein the drive shaft defines a first and second opposite ends, wherein the first end of the drive shaft is adapted to mechanically communicate with the first end of the rod, and the second end of the drive shaft is adapted to connect to a drive mechanism, wherein the rod can be rotated in a clockwise or anti-clockwise direction in response to rotation induced in the drive shaft; and
a base plate connected to the bottom of the housing, wherein the base plate is adapted to firmly attach to a floor;
whereby, an operator can use a drive mechanism to rotate the drive shaft and thence rotate the rod to cause the first end of the first shaft to be pushed away from the first end of the housing thereby simultaneously extending the first and second hollow shafts from the second end of the housing and thence moving the elongated push member away from the housing to push shelving, whereby upon removing the locking pin joining the first and second hollow shafts and rotating the rod in the opposite direction allows the first shaft to be driven back into the housing independently of the second shaft whereupon an operator can rejoin the second shaft to the inner shaft by placing the locking pin through a pair of aligned apertures in the first and second shafts.

4. The apparatus for moving shelving according to claim 3, further comprising a rod mounting bearing member to provide additional support to the rod without obstructing rotation of the rod.

5. The apparatus for moving shelving according to claim 3, further comprising a pillar, wherein the pillar is fitted with a rod mounting bearing member to provide additional support to the rod without obstructing rotation of the rod.

6. The apparatus for moving shelving according to claim 3, wherein the base plate defines a plurality of holes, wherein each hole is adapted to accommodate a floor securing bolt.

7. The apparatus for moving shelving according to claim 3, further comprising one or more hollow shafts that can be connected to said first hollow shaft and serve to extend the length of said first hollow shaft.
